(19) United States
(12) Patent Application Publication
(10) Pub. No.: US 2017/0123430 A1
(43) Pub. Date: May 4, 2017

(54) IN-PATH TARGET SELECTION DURING LANE CHANGE

(71) Applicant: Ford Global Technologies, LLC, Dearborn, MI (US)

(72) Inventors: Nitendra Nath, Troy, MI (US); Aaron L. Mills, Ann Arbor, MI (US)

(73) Assignee: Ford Global Technologies, LLC, Dearborn, MI (US)

(21) Appl. No.: 14/927,510

(22) Filed: Oct. 30, 2015

(51) Int. Cl. G05D 1/02; B62D 15/02

(52) U.S. Cl. CPC G05D 1/0223; B62D 15/0255

(57) ABSTRACT

A computing device for a host vehicle includes a data storage medium and a processing device. The computing device is programmed to detect a host vehicle lane change from a first lane to a second lane, ignore a current target vehicle in the first lane before the host vehicle completes the lane change, and select a vehicle in the second lane as a new target vehicle before the host vehicle completes the lane change.

### BACKGROUND

Autonomous vehicles are subject to the same situations as human-driven vehicles. For example, autonomous vehicles will encounter potholes, closed lanes, stalled vehicles, and debris in the roadway. Some obstacles are easier to navigate around than others. For example, navigating around a stationary object is easier for a human driver as well as an autonomous vehicle. Avoiding moving objects, including other vehicles, can be more difficult.

### BRIEF DESCRIPTION OF THE DRAWINGS

FIG. 1 illustrates an example host vehicle having a computing device that is programmed to detect a lane change maneuver and select a new in-path target vehicle before the lane change maneuver is complete.

FIG. 2 is a block diagram of example components of the host vehicle.

FIGS. 3A-3D illustrate example lane change and in-path target selection scenarios.

FIG. 4 is a flowchart of an example process that may be executed by the computing device to detect the lane change maneuver and select a new in-path target vehicle.

### DETAILED DESCRIPTION

Vehicle target selection refers to to selecting an in-path vehicle (i.e., a vehicle in the lane of the host vehicle) as a target vehicle to follow when the host vehicle is operating in an autonomous or partially autonomous mode. By “following” the target vehicle, the host vehicle may make certain adjustments relative to its own latitudinal and longitudinal control. That is, the host vehicle may set its speed, direction, or both, based on the speed or direction of the target vehicle.

Lane change maneuvers performed by the host vehicle may complicate the target selection, however. For example, the host vehicle may continue to track the current in-path target too long during the lane change maneuver, meaning that the host vehicle may be following a vehicle that is substantially in a different lane. This may prevent the host vehicle from resuming its set speed or adapting to a new target's speed present in the adjacent lane—something that may be considered against the driver's wish. Another issue may include the host vehicle briefly losing track of any in-path vehicle during the lane change, which may also cause a brief, but sudden, acceleration. Additionally, a “trickling” phenomenon of in-path targets can occur where the system first “locks-in” to farther range target before locking on to the closer range target. This may cause sudden acceleration followed by deceleration of the host vehicle. These responses from the vehicle may not be considered as favorable by the driver and may be discomforting. Sudden accelerations and/or decelerations may cause the driver to feel compelled to intervene or otherwise lose confidence in the autonomous or partially autonomous operation of the host vehicle.

An example computing device that can be incorporated into the host vehicle that manages the target selection during a lane change includes a data storage medium and a processing device. The computing device is programmed to detect a host vehicle lane change from a first lane to a second lane, ignore a current target vehicle in the first lane before the host vehicle completes the lane change, and select a vehicle in the second lane as a new target vehicle before the host vehicle completes the lane change. If multiple vehicles are in the second lane, the computing device may be programmed to select the vehicle closest to the host vehicle as the new target vehicle. Moreover, the computing device may be programmed to “drop” (i.e., ignore) the current target vehicle, and select the new target vehicle, as soon as the lane change maneuver is detected. If the vehicles in the second lane (i.e., the new lane) are too far away, the computing device may not identify an in-path vehicle during the lane change. With this implementation, the computing device may prevent sudden accelerations caused by, e.g., briefly losing track of any in-path vehicles or selecting an in-path vehicle that is too far away from the host vehicle. This also prevents sudden acceleration followed by deceleration caused by selecting farther away target first and then selecting the closer target as the host vehicle continues to move towards the adjacent lane.

The elements shown may take many different forms and include multiple and/or alternate components and facilities. The example components illustrated are not intended to be limiting. Indeed, additional or alternative components and/or implementations may be used. Further, the elements shown are not necessarily drawn to scale unless explicitly stated as such.

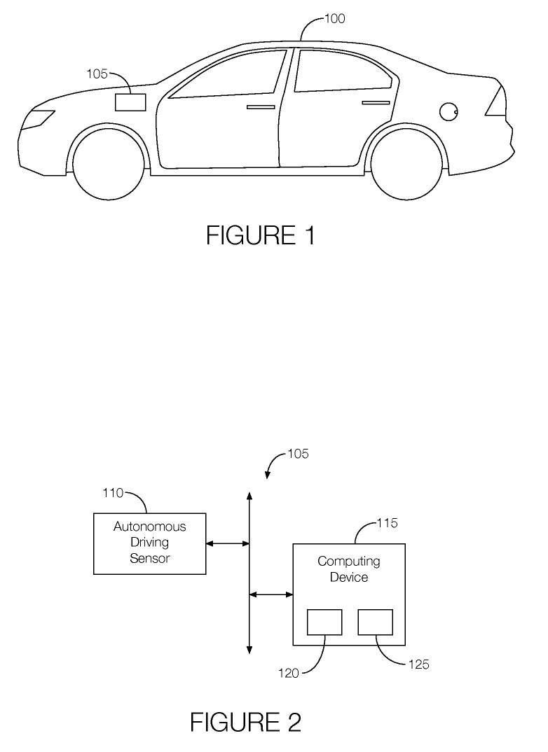

As illustrated in FIG. 1, the host vehicle 100 includes a vehicle system 105 programmed to manage the target selection during a lane change maneuver. Using on-board sensors, the vehicle system 105 detects when the host vehicle 100 begins the lane change maneuver. The on-board sensors may further be used to identify a current in-path target vehicle and vehicles in an adjacent lane. Upon detection of the lane change maneuver, the vehicle system 105 may immediately ignore the current in-path target vehicle and select one, if any, of the vehicles in the adjacent lane as the new target vehicle. Although illustrated as a sedan, the host vehicle 100 may include any passenger or commercial automobile such as a car, a truck, a sport utility vehicle, a crossover vehicle, a van, a minivan, a taxi, a bus, etc. In some possible approaches, the vehicle is an autonomous vehicle configured to operate in an autonomous (e.g., driverless) mode, a partially autonomous mode, and/or a non-autonomous mode.

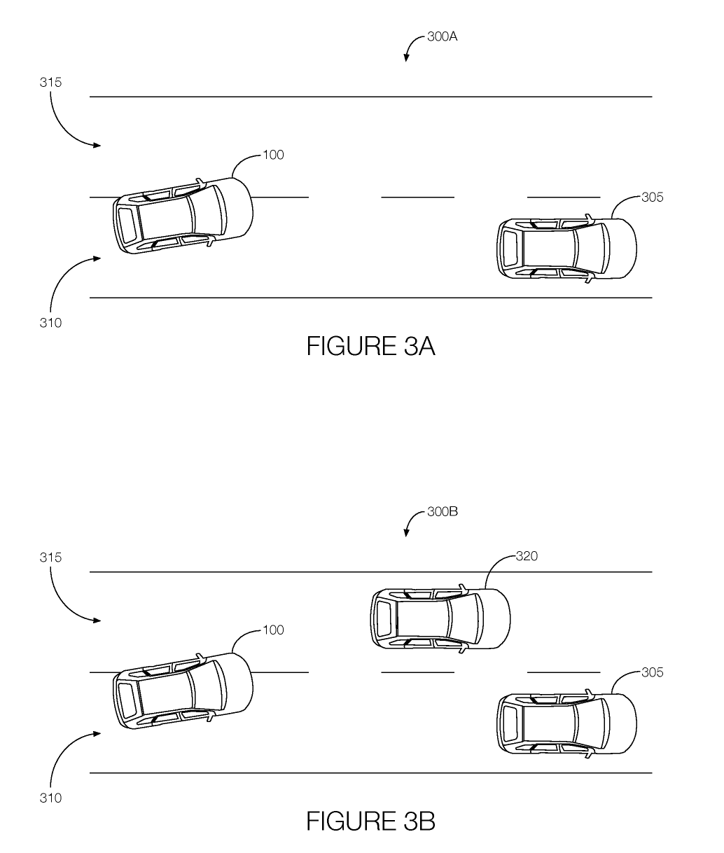

Referring now to FIG. 2, the vehicle system 105 includes at least one autonomous driving sensor 110 and a computing device 115.

The autonomous driving sensors 110 may include any number of devices configured, programmed, or both, to generate signals that help navigate the host vehicle 100 while the host vehicle 100 is operating in autonomous (e.g., driverless) or partially autonomous modes. Examples of autonomous driving sensors 110 may include a radar sensor, a lidar sensor, a vision sensor (e.g., a camera), or the like. The autonomous driving sensors 110, therefore, help the host vehicle 100 “see” the roadway, other vehicles, and the vehicle surroundings as well as help negotiate various obstacles while the host vehicle 100 is operating in a fully or partially autonomous mode.

The autonomous driving sensor 110 may be programmed to output various signals indicating, e.g., whether the host vehicle 100 is executing a lane change maneuver, the direction of the lane change maneuver, or the like. For instance, the autonomous driving sensor 110 may be programmed to detect a lane marker and output a signal representing the position of the host vehicle 100 relative to the lane marker. When the position of the host vehicle 100 is at a certain point relative to the lane marker, the signal output by the autonomous driving sensor 110 may be used to, e.g., determine that the host vehicle 100 has begun executing the lane change maneuver. The autonomous driving sensor 110 may make the determination of whether the host vehicle 100 is executing the lane change maneuver. Alternatively, the computing device 115 may determine whether the host vehicle 100 is executing the lane change maneuver based on signals output by the autonomous driving sensor 110.

Besides the lane markers, the autonomous driving sensor 110 may be further programmed to detect vehicles near the host vehicle 100. For instance, the autonomous driving sensor 110 may be programmed to detect a current target vehicle. The current target vehicle may be a vehicle immediately in front of the host vehicle 100 in the present lane in which the host vehicle 100 is operating. The autonomous driving sensor 110 may be programmed to detect vehicles in adjacent lanes as well. For instance, the autonomous driving sensor 110 may be programmed to detect vehicles in adjacent lanes, including the lane to which the host vehicle 100 is moving during the lane change maneuver, that are near, next to, or ahead of the host vehicle 100. Besides simply detecting other vehicles, the autonomous driving sensor 110 may be programmed to measure or otherwise determine a distance between the host vehicle 100 and the other vehicles, and output a signal representing that determined distance.

The computing device 115 may be programmed to receive and process the signals output by the autonomous driving sensor 110. From those signals, the computing device 115 may be programmed to detect the lane change maneuver from, e.g., a first lane to a second lane, ignore the current target vehicle in the first lane as soon as the lane change maneuver is detected and before the lane change maneuver is complete, and select one of the vehicles, if any, in the second lane as the new target vehicle before the host vehicle 100 completes the lane change.

In one possible implementation, the computing device 115 may determine that the host vehicle 100 is executing the lane change based on the signal output by the autonomous driving sensor 110 that indicates the position of the host vehicle 100 relative to a lane marker. Alternatively or in addition, the computing device 115 may determine that the host vehicle 100 is executing the lane change using other information such as, e.g., a steering angle signal representing an angle of a steering wheel or a turn indicator signal representing a state of a turn indicator (e.g., left turn, right turn, or off).

The computing device 115 may be further programmed to output command signals to autonomously control the host vehicle 100 before, during, and after the lane change maneuver. Depending on the location of the new target vehicle, the computing device 115 may command the host vehicle 100 (via one or more subsystems) to accelerate, decelerate, or maintain a present speed. For instance, if the new target vehicle is a significant distance from the host vehicle 100, the computing device 115 may command the host vehicle 100 to accelerate to, e.g., a predetermined speed during the lane change maneuver. The computing device 115 may command the host vehicle 100 to decelerate when, if ever, the host vehicle 100 catches up to the new target vehicle or if the in-path target vehicle changes to a closer vehicle. If the new target vehicle is fairly close to the host vehicle 100, the computing device 115 may command the host vehicle 100 to accelerate or decelerate to, e.g., match the speed of the new target vehicle during and after the lane change maneuver.

If the new target vehicle is too far away from the host vehicle 100, the computing device 115 may be programmed to at least temporarily ignore the new target vehicle. The distance from the new target vehicle may be determined from, e.g., signals output by the autonomous driving sensors 110. By temporarily ignoring the new target vehicle, the computing device 115 may prevent the host vehicle 100 from suddenly accelerating to catch up to the new target vehicle after the lane change maneuver is complete. Thus, the new target vehicle may be ignored during the lane change maneuver and possibly some time after the lane change maneuver until the new target vehicle is identified as the in-path vehicle.

If multiple vehicles are present in the adjacent lane, the computing device 115 may be programmed to select one of those vehicles as the new target vehicle. For instance, multiple adjacent vehicles may be detected by the autonomous driving sensors 110, and the computing device 115 may be programmed to select the adjacent vehicle that is currently closest to the host vehicle 100 or will be closest to the host vehicle 100 when the host vehicle 100 completes the lane change maneuver. By selecting and adapting the speed of the host vehicle 100 to the closest adjacent vehicle, the computing device 115 may prevent the host vehicle 100 from suddenly accelerating and then decelerating, which may occur if the computing device 115 toggles between potential target vehicles during the lane change maneuver.

The computing device 115 may be implemented, at least in part, via a data storage medium 120 and at least one processing device 125. The data storage medium 120 may be configured, programmed, or both, to store data including computer-readable instructions. The processing device 125 may be programmed to access and execute the computer-readable instructions stored in the data storage medium 120. For instance, the processing device 125 may be programmed to detect a host vehicle lane change from, e.g., a first lane to a second lane. The lane change may be detected from signals output by the autonomous driving sensor 110. Additionally or alternatively, the lane change may be detected from, e.g., a steering angle signal representing a steering wheel angle (which would change during a lane change). The steering angle signal may be generated by a steering system, and the steering angle may be determined from, e.g., a sensor, such as an encoder, configured to measure the steering wheel angle. Another way for the processing device 125 to detect the lane change may be based on a turn indicator signal. For instance, when the driver of the host vehicle 100 actuates a turn indicator, the processing device 125 may receive a turn indicator signal indicating that the host vehicle 100 is about to execute a lane change as well as the direction of the lane change.

In response to detecting the host vehicle 100 lane change, the processing device 125 may be programmed to ignore the current target vehicle, which may be located in the path of the host vehicle 100 in the first lane. The processing device 125 may be programmed to ignore the current target vehicle before the host vehicle 100 completes the lane change. In some possible implementations, the processing device 125 may ignore the current target vehicle when, e.g., the host vehicle 100 is 10% or 25% into the lane change as determined by the position of the host vehicle 100 relative to a lane marker. Immediately after ignoring the current target vehicle, the processing device 125 may be programmed to select a vehicle in the second lane as the new target vehicle. Because the new target vehicle is selected immediately after the previous target vehicle (i.e., the target vehicle in the path of the host vehicle 100 in the first lane) is ignored, the new target vehicle is selected before the host vehicle 100 completes the lane change. Therefore, the processing device 125 will recognize the new target vehicle before the host vehicle 100 is fully in the second lane. The processing device 125 may be programmed to output control signals to control one or more vehicle subsystems based on the new target vehicle. Thus, the control signals may cause the host vehicle 100 to adapt to the new target vehicle. Because the new target vehicle is selected immediately after the previous target vehicle was ignored, and because the new target vehicle is selected during the lane change, the processing device 125 is less likely to command the host vehicle 100 to suddenly accelerate or decelerate before or during the transition to the second lane. However, the control signal may cause the host vehicle 100 to accelerate, decelerate, or maintain its present speed depending on the distance between the host vehicle 100 and the new target vehicle.

In some instances, such as if the new target vehicle is too far away, the processing device 125 may be programmed to ignore the new target vehicle for the remainder of the lane change maneuver. For instance, the processing device 125 may determine, from signals output by the autonomous mode controller, the distance of the new target vehicle to the host vehicle 100. If the distance exceeds a predetermined threshold, the processing device 125 may command the host vehicle 100 to execute the lane change maneuver as if there is no new target vehicle. Once the host vehicle 100 is fully in the lane, the processing device 125 may determine that the lane change maneuver is complete and reconsider how to control the host vehicle 100 relative to the current in-path vehicle.

The processing device 125 may be further programmed to compensate for changes that occur during the lane change maneuver. For instance, the processing device 125 may be programmed to identify the new target vehicle in the second lane during the lane change maneuver. If another vehicle in the second lane, referred to as an intervening vehicle, comes between the host vehicle 100 and the new target vehicle during the lane change maneuver, the processing device 125 may be programmed to identify the intervening vehicle as the new target vehicle and adjust the speed of the host vehicle 100 accordingly, including commanding the host vehicle 100 to accelerate, decelerate, or maintain its current speed.

Another instance may include the host vehicle 100 beginning a lane change maneuver from the first lane to the second lane, but then returning to the first lane before the lane change maneuver is complete. In this instance, the processing device 125 may initially ignore the current target vehicle, select a new target vehicle during the lane change maneuver to the second lane, ignore the new target vehicle in the second lane during the lane change maneuver to the first lane, and select the previous or possibly a different target vehicle in the first lane prior to completing the lane change maneuver back to the first lane.

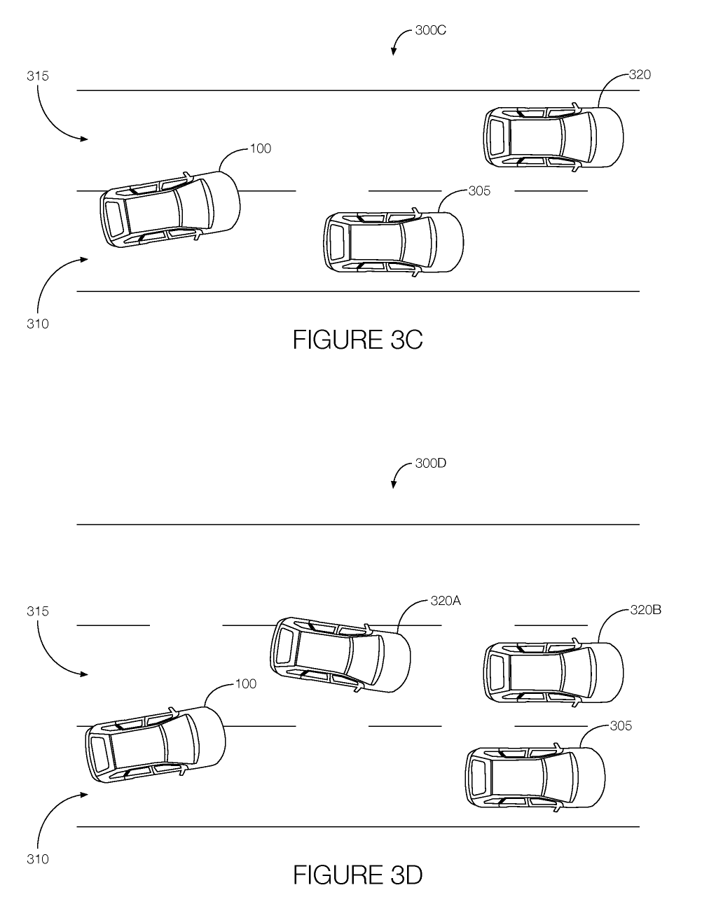

FIGS. 3A-3D illustrate example lane change and in-path target selection scenarios. FIG. 3A illustrates an example scenario 300A where the host vehicle 100 is following a current target vehicle 305 in a first lane 310, detects the lane change maneuver from the first lane 310 to a second lane 315, and ignores the current target vehicle 305 before the lane change maneuver is complete. Since there are no nearby vehicles in the second lane 315, the host vehicle 100 does not select a vehicle in the second lane 315 as a new target in-path vehicle.

FIGS. 3B-3C illustrates scenarios 300A, 300B where the host vehicle 100 is following the current in-path target vehicle 305 in the first lane 310 and begins the lane change maneuver to the second lane 315. In both scenarios 300A, 300B, the host vehicle 100 immediately ignores the current target vehicle 305 upon detecting the lane change maneuver and identifies the new target vehicle 320 in the second lane 315 before the lane change maneuver is complete. In the scenario 320 of FIG. 3B, the new target vehicle 320 is traveling slower than the host vehicle 100 or would otherwise be closer to the host vehicle 100 than if the host vehicle 100 were continuing to follow the previous target vehicle 310. Therefore, the host vehicle 100 may decelerate after the new target vehicle 320 is selected. In the scenario of FIG. 3C, the new target vehicle 320 is traveling faster than the host vehicle 100 or is otherwise further away from the previous target vehicle 310. In this instance, the host vehicle 100 may accelerate during the lane change maneuver.

FIG. 3D illustrates a scenario 300D where two vehicles 320A and 320B are present in the second lane 315. If both are present when the host vehicle 100 detects the lane change maneuver, the host vehicle 100 may select the closer of the two (vehicle 320A, as shown in FIG. 3D) as the new target vehicle. In instances where the vehicle 320A is not present in the second lane 315 when the host vehicle 100 begins the lane change maneuver, which may occur if the vehicle 320A moves into the second lane 315 while the host vehicle 100 is executing the lane change maneuver, the host vehicle 100 may initially identify the vehicle 320B as the new in-path target vehicle and then subsequently identify the vehicle 320A as the new in-path target vehicle during the lane change maneuver. Thus, the host vehicle 100 may adjust its speed according to the position of the vehicle 320A relative to the host vehicle 100 during and after the lane change maneuver.

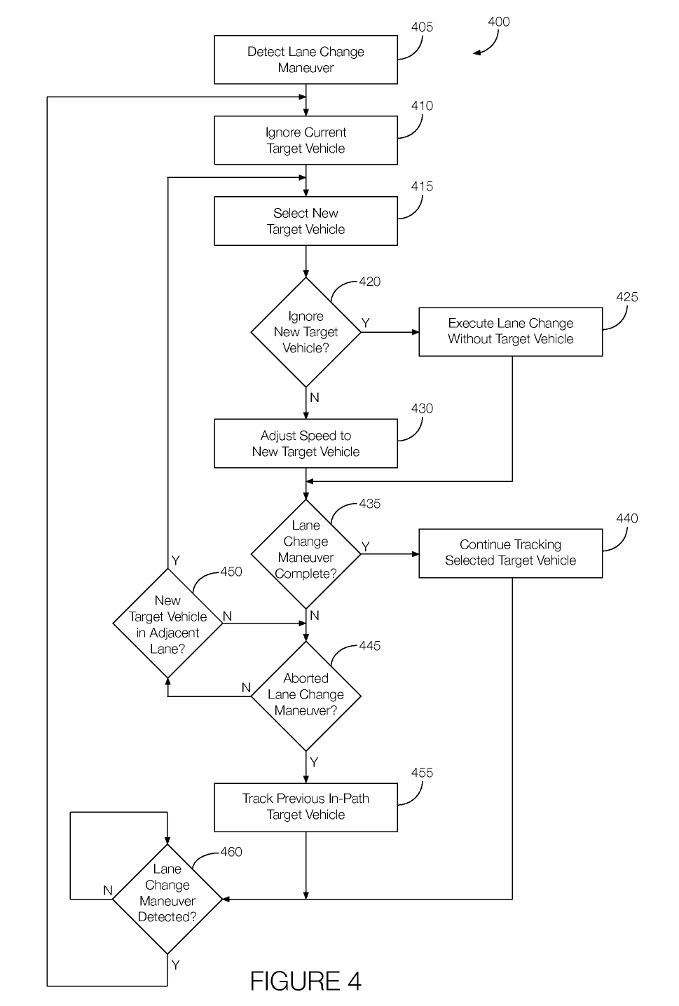

FIG. 4 is a flowchart of an example process 400 that may be executed by the computing device 115 to detect the lane change maneuver and select a new in-path target vehicle. The process 400 may be initiated any time while the host vehicle 100 is turned on, and in some instances, moving.

At block 405, the computing device 115 may detect a lane change of a host vehicle 100 from a first lane to a second lane. The lane change may be detected from signals output by the autonomous driving sensor 110 indicating a position of the host vehicle 100 relative to a lane marker. The computing device 115 may compare the position of the host vehicle 100 relative to the lane markers, and determine whether the host vehicle 100 is executing a lane change maneuver based on the position of the host vehicle 100 relative to the lane marker. Additionally, or in the alternative, the lane change may be detected from, e.g., a steering angle signal representing a steering wheel angle (which would change during a lane change). The steering angle signal may be generated by a steering system, and the steering angle may be determined from, e.g., a sensor, such as an encoder, configured to measure the steering wheel angle. Another way for the computing device 115 to detect the lane change may be based on a turn indicator signal. For instance, when the driver of the host vehicle 100 actuates a turn indicator, the computing device 115 may receive a turn indicator signal indicating that the host vehicle 100 is about to execute a lane change as well as the direction of the lane change.

At block 410, the computing device 115 may ignore a current target vehicle. The current target vehicle may be the in-path target vehicle before the host vehicle 100 begins to execute the lane change maneuver. The computing device 115 may ignore the current target vehicle before the host vehicle 100 completes the lane change. In some possible implementations, the computing device 115 may ignore the current target vehicle when, e.g., the host vehicle 100 is 10% or 25% into the lane change as determined by the position of the host vehicle 100 relative to a lane marker at block 405.

At block 415, the computing device 115 may select a vehicle in the second lane as the new target vehicle. The selection at block 415 may be made before the host vehicle 100 completes the lane change maneuver (i.e., before the host vehicle 100 is in the second lane). For instance, while executing the lane change maneuver, the computing device 115 may detect one or more vehicles in the second lane and select one of the vehicles, such as the vehicle in the second lane closest to the host vehicle 100, as the new target vehicle.

At decision block 420, the computing device 115 may determine whether to ignore the new target vehicle. The new target vehicle may be ignored for the remainder of the lane change maneuver if, e.g., the new target vehicle is too far away from the host vehicle 100. Therefore, determining whether to ignore the new target vehicle may include the computing device 115 estimating the distance of the host vehicle 100 to the new target vehicle based on, e.g., signals output by the autonomous driving sensor 110 and ignoring the new target vehicle if the distance to the new vehicle exceeds a predetermined threshold. If the new target maneuver is ignored, the process 400 may proceed to block 425. If the new target vehicle is not ignored, the process 400 may proceed to block 430.

At block 425, the computing device 115 may command the host vehicle 100 to execute the lane change maneuver as if there is no new target vehicle. The computing device 115 may, therefore, complete the lane change maneuver without accelerating or decelerating relative to a new target vehicle in the second lane. The process 400 may proceed to block 435.

At block 430, the computing device 115 may command the host vehicle 100 to adjust to the new target vehicle. For instance, the computing device 115 may command the host vehicle 100 to accelerate, decelerate, or maintain its current speed based on, e.g., a distance of the host vehicle 100 to the new target vehicle.

At decision block 435, the computing device 115 may determine whether the lane change maneuver is complete. That is, the computing device 115 may determine, from signals output by the autonomous driving sensor 110, if the host vehicle 100 is fully within the second lane. If so, the process 400 may continue to block 440.

At block 440, the computing device 115 may continue tracking the target vehicle selected at block 415. In some instances, the process 400 may end after block 440 so that a different process that involves following the current in-path vehicle may be initiated until the next lane change maneuver is detected. Therefore, with the host vehicle 100 is fully in the new lane, the computing device 115 may consider how to control the host vehicle 100 relative to the current in-path vehicle. Alternatively, as shown in FIG. 4, the process 400 may proceed to block 460 to await a new lane change maneuver while the host vehicle 100 is controlled relative to the in-path vehicle.

At block 445, the computing device 115 may determine whether the host vehicle 100 has aborted the lane change maneuver. If so, the computing device 115 may ignore the new target vehicle and instead focus on the previous target vehicle in the first lane as the in-path vehicle (see block 455). The process 400 may proceed then to block 460 to await a new lane change maneuver. If the lane change maneuver has not been aborted, the process 400 may proceed to block 450.

At decision block 450, the computing device 115 may determine whether a new vehicle has been detected in the adjacent lane. If so, the process 400 may proceed to block 415 so that the new vehicle may be considered as a new target vehicle. If no new vehicles are in the adjacent lane, the process 400 may return to block 445.

At block 455, the computing device 115 may track the previous in-path target vehicle, which may include the vehicle being tracked prior to block 410. To avoid sudden accelerations, decelerations, or both, the computing device 115 may immediately ignore the new target vehicle selected at block 415 as soon as the computing device 115 determines that the lane change maneuver has been aborted. The process 400 may proceed to block 460 to await a subsequent lane change maneuver.

At decision block 460, the computing device 115 may determine whether a new lane change maneuver is detected. The new lane change maneuver may be detected by the autonomous driving sensors 110 as discussed above. The block 460 may repeat until the new lane change maneuver is detected. When the new lane change maneuver is detected, the process 400 may continue to block 410.

With this or a similar implementation, the computing device 115 can detect a lane change maneuver and select the appropriate in-path target vehicle before the lane change maneuver is complete. Moreover, by dropping the previous in-path vehicle at the time the lane change maneuver is detected, the computing device 115 can avoid unnecessary accelerations or decelerations.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A computing device comprising a data storage medium and a processing device, wherein the computing device is programmed to:
detect a host vehicle lane change from a first lane to a second lane;
ignore a current target vehicle in the first lane before the host vehicle completes the lane change; and
select a vehicle in the second lane as a new target vehicle before the host vehicle completes the lane change.

2. The computing device of claim 1, further comprising an autonomous driving sensor programmed to detect the current target vehicle and the new target vehicle.

3. The computing device of claim 2, wherein the autonomous driving sensor is programmed to detect a lane marker and output a signal representing the host vehicle lane change based at least in part on a position of the host vehicle relative to the lane marker.

4. The computing device of claim 3, wherein the computing device is programmed to receive the signal representing the host vehicle lane change and detect the host vehicle lane change based at least in part on the signal representing the host vehicle lane change.

5. The computing device of claim 1, wherein the computing device is programmed to receive a steering angle signal and detect the host vehicle lane change based at least in part on the steering angle signal.

6. The computing device of claim 1, wherein the computing device is programmed to receive a turn indicator signal and detect the host vehicle lane change based at least in part on the turn indicator signal.

7. The computing device of claim 1, wherein the computing device is programmed to command the host vehicle to accelerate after selecting the new target vehicle.

8. The computing device of claim 1, wherein the computing device is programmed to command the host vehicle to decelerate after selecting the new target vehicle.

9. The computing device of claim 1, wherein the computing device is programmed to ignore the new target vehicle before the host vehicle completes the lane change based at least in part on a distance between the host vehicle and the new target vehicle.

10. The computing device of claim 1, wherein the computing device is programmed to identify a plurality of vehicles in the second lane and select one of the plurality of vehicles in the second lane as the new target vehicle.

11. A method comprising:
detecting a host vehicle lane change from a first lane to a second lane;
ignoring a current target vehicle in the first lane before the host vehicle completes the lane change; and
selecting a vehicle in the second lane as a new target vehicle before the host vehicle completes the lane change.

12. The method of claim 11, wherein detecting the host vehicle lane change includes:
detecting a lane marker; and
comparing a position of the host vehicle relative to the lane marker.

13. The method of claim 11, wherein detecting the host vehicle lane change includes:
receiving a steering angle signal; and
detecting the host vehicle lane change based at least in part on the steering angle signal.

14. The method of claim 11, wherein detecting the host vehicle lane change includes:
receiving a turn indicator signal; and
detecting the host vehicle lane change based at least in part on the turn indicator signal.

15. The method of claim 11, further comprising commanding the host vehicle to accelerate after selecting the new target vehicle.

16. The method of claim 11, further comprising commanding the host vehicle to decelerate after selecting the new target vehicle.

17. The method of claim 11, further comprising:
estimating a distance between the new target vehicle and the host vehicle; and
ignoring the new target vehicle before the host vehicle completes the lane change based at least in part on the estimated distance between the host vehicle and the new target vehicle.

18. The method of claim 11, further comprising:
identifying a plurality of vehicles in the second lane; and
selecting one of the plurality of vehicles in the second lane as the new target vehicle.

19. A vehicle system comprising:
at least one autonomous driving sensor programmed to detect a current target vehicle in a first lane and at least one vehicle in a second lane; and
a computing device having a data storage medium and a processing device, wherein the computing device is programmed to detect a host vehicle lane change from the first lane to the second lane, ignore the current target vehicle in the first lane before the host vehicle completes the lane change, and select one of the at least one vehicles in the second lane as a new target vehicle before the host vehicle completes the lane change.

20. The vehicle system of claim 19, wherein the autonomous driving sensor is programmed to detect a lane marker and output a signal representing the host vehicle lane change based at least in part on a position of the host vehicle relative to the lane marker, and wherein the computing device is programmed to ignore the current target vehicle in response to receiving the signal representing the host vehicle lane change.
